(19) United States
(12) Patent Application Publication
(10) Pub. No.: US 2026/0192798 A1
(43) Pub. Date: Jul. 9, 2026

(54) VEHICLE CONTROL DEVICE

(71) Applicant: HONDA MOTOR CO., LTD., Tokyo (JP)

(72) Inventor: Takuma KOBAYASHI, Tokyo (JP)

(21) Appl. No.: 19/369,695

(22) Filed: Oct. 27, 2025

(30) Foreign Application Priority Data
Nov. 8, 2024 (JP) 2024-195909

(51) Int. Cl. B60W 30/09; B60W 30/12; B60W 50/14; G06V 20/59

(52) U.S. Cl. CPC B60W 30/09; B60W 30/12; B60W 50/14; G06V 20/597; B60W 2540/223; B60W 2540/225

(57) ABSTRACT

A vehicle control device 1 includes a surrounding situation recognizer 51 configured to recognize a surrounding situation of a vehicle 2, a travel controller 52 as a driving assister configured to perform driving assistance for the vehicle 2 based on a recognition result of the surrounding situation recognizer 51, and a driver state determiner 56 configured to determine whether a state of a driver is normal or abnormal based on an image captured by an in-vehicle camera 25 that captures an image of the driver of the vehicle 2. The driver state determiner 56 is configured such that the state of the driver is more likely to be determined as abnormal when the driving assistance is being performed by the travel controller 52 than when the driving assistance is not being performed.

### TECHNICAL FIELD

The present invention relates to a vehicle control device that controls the traveling of a vehicle to assist driving, and more specifically, to a vehicle control device that performs driving assistance based on a state of a driver of the vehicle.

### BACKGROUND ART

In recent years, efforts have been actively made to provide access to sustainable transport systems that take into account people in vulnerable situations among traffic participants. To achieve this, research and development for further improving safety and convenience of traffic through development of driving assistance technologies is attracting attention.

Conventionally, a travel control device that includes a surrounding detection unit that detects a surrounding situation of a vehicle, and a lane keeping control unit that executes lane keeping control based on a detection result of a lane mark by the surrounding detection unit is known in the art (see, for example, JP2017-146817A). The travel control device determines whether a lane change can be made based on the lane change intention of a driver, and notifies the driver of the determination result via a display and/or a speaker.

JP2016-71577A discloses a driver state detection device that uses changes in the facial expression of the driver to accurately determine whether the driver is in a distracted state. The driver state detection device detects changes in specific facial portions of the driver captured by an imaging device, and determines that the driver is in a distracted state when a temporary change in the specific portion continues for a prescribed time period or longer.

JP2018-149941A discloses a concentration determination device that takes into consideration both driving safety and driving comfort. The concentration determination device includes a monitoring data acquisition unit that acquires monitoring data from a sensor that monitors the driver of the vehicle, and a concentration estimation unit that estimates the level of driving concentration of the driver based on a prescribed index from the monitoring data. In a case where the level of driving concentration does not satisfy a prescribed criterion, a command signal for providing assistance to the driver is output.

However, in the prior arts, the accuracy of a driver camera that captures the image of the driver is low, and determining an abnormal state of the driver requires time. Therefore, even in a truly dangerous situation, there is a risk that the notification to the driver is delayed due to the time required for determining whether the state of the driver is abnormal.

### SUMMARY OF THE INVENTION

In view of the above background, an object of the present invention is to appropriately determine an abnormal state of a driver according to a driving situation and to reduce delay in notifying the driver. This will ultimately contribute to the development of a sustainable transport system.

To achieve such an object, one aspect of the present invention provides a vehicle control device including: a surrounding situation recognizer configured to recognize a surrounding situation of a vehicle; a driving assister configured to perform driving assistance for the vehicle based on a recognition result of the surrounding situation recognizer; and a driver state determiner configured to determine whether a state of a driver is normal or abnormal based on an image captured by an in-vehicle camera that captures an image of the driver of the vehicle. The driver state determiner is configured such that the state of the driver is more likely to be determined as abnormal when the driving assistance is being performed by the driving assister than when the driving assistance is not being performed.

Thus, according to the above aspects, since the state of the driver is more likely to be determined as abnormal when the driving assistance is being performed by the driving assister, it is possible to appropriately determine the abnormal state of the driver according to the driving situation and to reduce the delay in notifying the driver.

### BRIEF DESCRIPTION OF THE DRAWING(S)

FIG. 1 is a block diagram of a vehicle system according to an embodiment of the present invention;

FIG. 2 shows an image captured by an in-vehicle camera;

FIG. 3A is an explanatory diagram of an example of an inappropriate driving state in the image captured by the in-vehicle camera;

FIG. 3B is an explanatory diagram of an example of an inappropriate driving state in the image captured by the in-vehicle camera;

FIG. 4 is a flowchart showing a procedure for driving assistance control by a control device;

FIG. 5 is a time chart of an example of the driving assistance control when travel control is not being executed; and

FIG. 6 is a time chart of an example of the driving assistance control when the travel control is being executed.

### DETAILED DESCRIPTION OF THE INVENTION

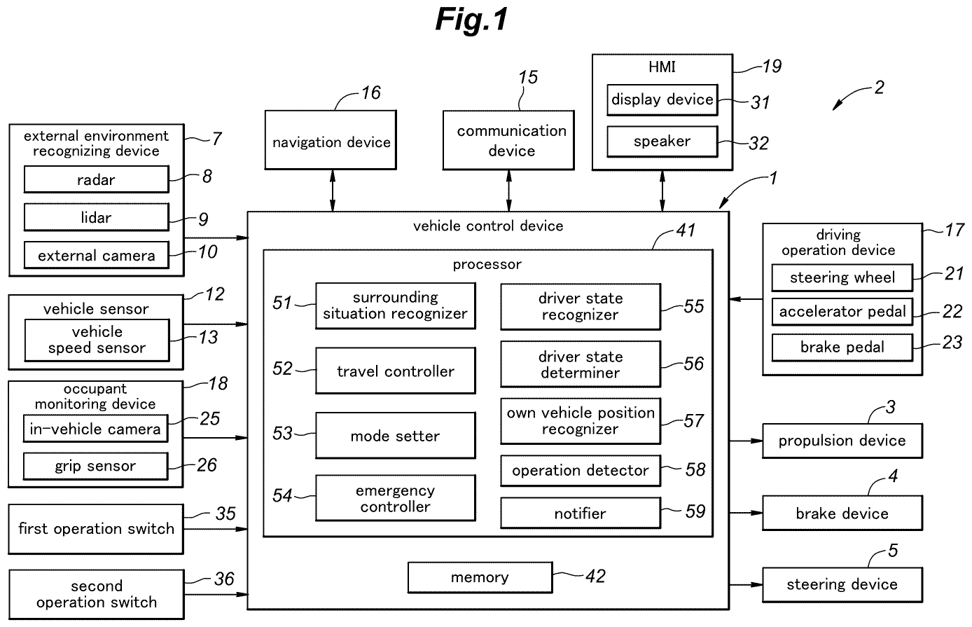

As shown in FIG. 1, a vehicle control device 1 is provided in a vehicle 2. The vehicle 2 may be, for example, a four-wheeled automobile. The vehicle 2 is an autonomous driving vehicle or a vehicle with a driving assistance function.

The vehicle 2 includes a propulsion device 3, a brake device 4, and a steering device 5. The propulsion device 3 is a device that provides the driving force to the vehicle 2, and includes, for example, a power source and a transmission. The power source includes at least one of an internal combustion engine such as a gasoline engine or a diesel engine, and an electric motor. The brake device 4 is a device that applies the braking force to the vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the vehicle control device 1.

The vehicle 2 includes an external environment recognizing device 7. The external environment recognizing device 7 is a device for detecting objects outside the vehicle 2 and the like. The external environment recognizing device 7 is a sensor that captures electromagnetic waves and light from the surroundings of the vehicle 2 to detect the objects outside the vehicle 2. The external environment recognizing device 7 includes, for example, a radar 8, a lidar 9 (LIDAR), and an external camera 10.

The vehicle 2 includes a vehicle sensor 12. The vehicle sensor 12 includes a vehicle speed sensor 13 that detects the speed of the vehicle 2, an acceleration sensor that detects the acceleration thereof, a yaw rate sensor that detects the angular velocity around the vertical axis, an azimuth sensor that detects the orientation of the vehicle 2, and the like.

The vehicle 2 includes a communication device 15, a navigation device 16, a driving operation device 17, an occupant monitoring device 18, and an HMI 19 (Human Machine Interface). The communication device 15 mediates communication between the components (for example, the vehicle control device 1 and the navigation device 16) of the vehicle 2 and the devices (for example, a surrounding vehicle and a server) arranged outside the vehicle 2.

The navigation device 16 is a device that acquires the current position of the vehicle 2 and provides route guidance to the destination, and the like. The navigation device 16 may include a GNSS receiving unit, a map storage unit, a navigation interface, and a route determination unit. The GNSS receiving unit determines the position (latitude and longitude) of the vehicle 2 based on signals received from artificial satellites (positioning satellites). The map storage unit is composed of a known storage device such as flash memory or a hard disk, and stores map information. The navigation interface accepts the input of information such as the destination by the occupant, and presents various information to the occupant via display and audio. The navigation interface may include, for example, a touch panel display, a speaker 32, and the like.

The driving operation device 17 accepts input operations performed by the occupant (driver) to control the vehicle 2. The driving operation device 17 includes a steering wheel 21, an accelerator pedal 22, and a brake pedal 23. The driving operation device 17 may also include a shift lever, a parking brake lever, and the like. Each component of the driving operation device 17 is provided with a sensor that detects the operation amount. The driving operation device 17 outputs a signal indicating the operation amount to the vehicle control device 1.

The occupant monitoring device 18 monitors the state of the occupant inside a vehicle cabin. The occupant monitoring device 18 includes, for example, an in-vehicle camera 25 that captures an image of the occupant seated on a seat inside the vehicle cabin, and a grip sensor 26 provided on the steering wheel 21. The in-vehicle camera 25 is a digital camera that uses a solid-state image sensor such as a CCD or CMOS. The grip sensor 26 detects whether the driver is gripping the steering wheel 21. The grip sensor 26 may be formed, for example, of a capacitance sensor or a piezoelectric element provided on the steering wheel 21.

The HMI 19 notifies the occupant of various information by display and audio, and accepts input operations by the occupant. The HMI 19 includes the display device 31 and the speaker 32. The display device 31 may be a touch panel display including a liquid crystal display or an organic electroluminescence display. The display device 31 may also function as a navigation interface. The display device 31 and the speaker 32 function as notification devices for notifying the occupant by images and audio. Here, the image may be a video including a number of consecutive frames. The HMI 19 may also include various actuators. For example, the actuator may be configured to act on the six senses of the driver, such as a vibration actuator incorporated into the steering wheel 21 or a belt tightening device incorporated into a seat belt retractor.

The vehicle 2 includes a first operation switch 35 and a second operation switch 36. The first operation switch 35 and the second operation switch 36 are switches that can be operated by the occupant. The first operation switch 35 and the second operation switch 36 may be mechanical switches or GUI switches displayed on a touch panel, and are arranged at appropriate positions inside the vehicle cabin. The first operation switch 35 and the second operation switch 36 may be composed of the display device 31 or the navigation interface. The first operation switch 35 may be a switch for turning on and off the driving assistance control. The second operation switch 36 is preferably a switch for selecting a driving assistance control to be executed from the driving assistance control of plural types, and for setting the level of autonomous driving. The second operation switch 36 may be, for example, a rotary switch. The first operation switch 35 and the second operation switch 36 may be integrated into a common switch.

The vehicle control device 1 is a computer including a processor 41 and a memory 42 communicatively connected to the processor 41. The processor 41 may include at least one of the following cores: a central processing unit (CPU), a graphics processing unit (GPU), and a reduced instruction set computer (RISC). The memory 42 stores the control program executed by the processor 41 and various data. The memory 42 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle control device 1 may be realized by hardware such as a large scale integration (LSI), an application specific integrated circuit (ASIC), or a field-programmable gate array (FPGA), or may be realized by a combination of software and hardware. The vehicle control device 1 may be composed of a single piece of hardware, or may be composed of plural pieces of hardware capable of communicating with each other. A portion of the vehicle control device 1 may be composed of an external server provided outside the vehicle 2.

The processor 41 realizes various applications by executing the control program stored in the memory 42. The control program may be stored in a removable recordable medium such as a DVD or a CD-ROM, and installed in the memory 42 as the recordable medium is read by a reading device. The control program may also be downloaded and installed in the memory 42 via a communication network such as the Internet.

By executing the control programs stored in the memory 42, the processor 41 functions as a surrounding situation recognizer 51, a travel controller 52, a mode setter 53, an emergency controller 54, a driver state recognizer 55, a driver state determiner 56, an own vehicle position recognizer 57, an operation detector 58, and a notifier 59. The processor 41 executes the control program, and the vehicle control device 1, which is a computer, executes the vehicle control method.

The surrounding situation recognizer 51 recognizes the surrounding situation of the vehicle 2. The surrounding situation recognizer 51 recognizes the surrounding situation (external environment), including obstacles located around the vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The surrounding situation recognizer 51 can acquire the position, speed, acceleration, and other states of the surrounding vehicles from the detection results of the external environment recognizing device 7.

The own vehicle position recognizer 57 recognizes the lane in which the vehicle 2 is traveling, and the relative position and angle of the vehicle 2 with respect to the lane in which the vehicle 2 is traveling. The own vehicle position recognizer 57 may recognize the travel lane based on the map information and the position of the vehicle 2 acquired by the GNSS receiving unit. Further, the own vehicle position recognizer 57 extracts the dividing lines around the vehicle 2 drawn on the road surface from the map information, and compares the dividing lines from the map information with the shapes of the dividing lines captured by the external camera 10, thereby recognizes the relative position and angle of the vehicle 2 with respect to the travel lane.

The driver state recognizer 55 recognizes the situation of the driver. The driver state recognizer 55 recognizes the state of the driver and the holding state of the steering wheel 21 by the driver based on the detection result of the occupant monitoring device 18. The state of the driver includes the position of the head, the orientation of the face, the open/closed state of the eyes, and the direction of the sight-line of the driver. The driver state recognizer 55 can acquire such state information of the driver from the detection results of the in-vehicle camera 25.

The driver state determiner 56 determines the state of the driver. The driver state determiner 56 determines, based on a signal from the occupant monitoring device 18, whether the state of the driver is a surrounding monitoring state. The surrounding monitoring state is a state suitable for driving, in which the driver monitors the surroundings of the vehicle 2 and satisfies a prescribed suitability criterion. This state is required for autonomous driving of level 2 or lower, where the driver has a duty to monitor the surroundings. In the surrounding monitoring state, it is preferable that the driver is in a state where the driver can initiate manual driving quickly. For example, in the surrounding monitoring state, the driver is seated on the seat facing forward and monitors the area in front of the vehicle 2. The driver state determiner 56 may, for example, acquire the posture or head orientation of the driver based on an image from the in-vehicle camera 25, and determine that the state of the driver is the surrounding monitoring state in a case where the posture or head orientation of the driver corresponds to a prescribed surrounding monitoring posture. Further, the driver state determiner 56 may, for example, acquire the sight-line of the driver based on an image from the in-vehicle camera 25, and determine that the state of the driver is the surrounding monitoring state that satisfies the suitability criteria in a case where the sight-line of the driver is directed forward. Further, the driver state determiner 56 may determine that the state of the driver is the surrounding monitoring state in a case where the steering wheel 21 is gripped by the driver based on a signal from the grip sensor 26. Further, the driver state determiner 56 may determine that the state of the driver is the surrounding monitoring state in a case where the sight-line of the driver is directed forward and the steering wheel 21 is gripped by the driver.

In the autonomous driving of level 3 or higher, where the driver does not have a duty to monitor the surroundings, an abnormal state means a state in which the driver is unable to quickly take over driving when a takeover request is issued. The state in which the driver is unable to take over driving is a state in which the driver is unable to monitor a screen display that displays a warning, and includes a state in which the driver is asleep or looking backward. In the present embodiment, in the autonomous driving of level 3, the suitability criteria include conditions for ensuring that the driver fulfills the duty of monitoring the surroundings of the vehicle when the driver is notified to do so.

At each level of autonomous driving, in a case where the prescribed suitability criteria are not satisfied, the driver state determiner 56 determines that the driver is not in a normal state according to the autonomous driving level and determines the state of the driver as abnormal.

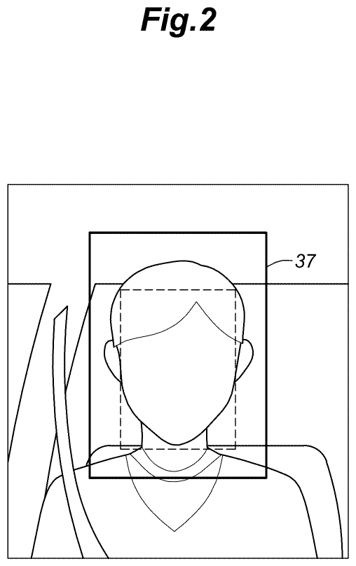

FIG. 2 shows an image taken by the in-vehicle camera 25. As shown in FIG. 2, the driver state determiner 56 sets the prescribed area 37 in the image of the driver's seat captured by the in-vehicle camera 25, the prescribed area 37 being an area where the head of the driver should be located during driving. In the present embodiment, the driver state determiner 56 sets the prescribed area 37 as a vertically elongated rectangular shape. In other embodiments, the prescribed area 37 may be set in a shape other than a rectangle. The position and size of the prescribed area 37 may be appropriately set according to the position and size of the head of the driver seated in the driver's seat. The shape of the prescribed area 37 may also be set according to the shape of head of the driver.

The driver state determiner 56 analyzes the images captured by the in-vehicle camera 25 and sequentially detects the head of the driver. More specifically, the driver state determiner 56 extracts edges representing the outline of the face of the driver from the image of the driver's seat, and detects a rectangular area, surrounded by vertical lines passing through the left and right ends of the extracted edges and horizontal lines passing through the top and bottom ends of the edges, as the head (face). The prescribed area 37 is set to a size obtained by adding prescribed margins to the left and right and above and below the detected head. When the driver is in the surrounding monitoring state, the face of the driver is positioned substantially in the center of the prescribed area 37. The driver state determiner 56 acquires the trajectory of the head of the driver based on the sequentially detected positions of the head of the driver.

The driver state determiner 56 also detects facial features such as the eyes, nose, and mouth from the face of the driver. The driver state determiner 56 detects the orientation of the face of the driver based on the outline of the face and the positions of the facial features of the driver. The orientation of the face is calculated as a deflection direction and a deflection degree (angle) relative to the forward direction toward which the face of the driver should be oriented during driving. The driver state determiner 56 acquires a change in the orientation of the face of the driver based on the sequentially detected orientations of the face of the driver.

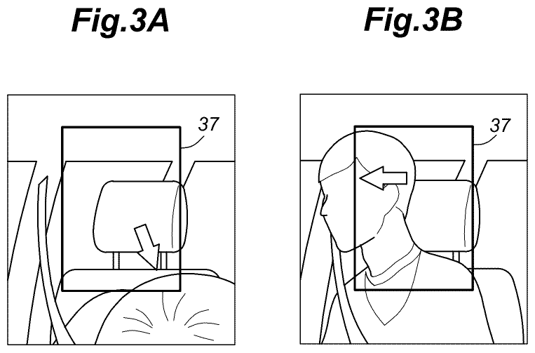

FIGS. 3A and 3B are explanatory diagrams of the change in the position of the head in the image captured by the in-vehicle camera 25. The driver in the surrounding monitoring state as shown in FIG. 2 may significantly tilt the head forward as shown in FIG. 3A. For example, this may occur when the driver suddenly becomes ill. In this case, the driver state determiner 56 detects that the head of the driver has moved out of the prescribed area 37 in the downward direction, and determines that the driver is in an inappropriate state that fails to satisfy the suitability criteria according to the autonomous driving level.

As shown in FIG. 3B, the driver may move the head laterally during driving. For example, this may occur when the driver visually checks the line marking through a side window or checks the rear of the vehicle 2 by direct vision. In this case, the driver state determiner 56 detects that the head of the driver has moved out of the prescribed area 37 in the vehicle width direction as shown in FIG. 3B, and determines that the state of the driver is in the inappropriate state that fails to satisfy the prescribed suitability criteria.

In this way, the driver state determiner 56 determines that the driver is in the inappropriate state when at least one of the prescribed conditions set in the suitability criteria is not satisfied. When the inappropriate state continues for the prescribed time threshold, the driver state determiner 56 determines that the state of the driver is abnormal. The driver state determiner 56 determines that the state of the driver is normal unless the inappropriate state continues for the prescribed time threshold. Further, even if the state of the driver has once been determined as abnormal, when the state of the driver returns from the inappropriate state to the appropriate state, such as a surrounding monitoring state, the driver state determiner 56 determines that the state of the driver is normal.

Returning to FIG. 1, the description will be continued. The operation detector 58 acquires the operation amount of the driving operation device 17 based on a signal from the driving operation device 17. The operation detector 58 acquires the operation amount of the brake pedal 23, the accelerator pedal 22, and the steering wheel 21 based on signals from sensors provided on the brake pedal 23, the accelerator pedal 22, and the steering wheel 21. That is, the operation detector 58 is configured to be able to detect the operation of the brake pedal, the accelerator pedal, and the steering wheel by the driver.

The operation detector 58 is configured to detect the operations on the first operation switch 35 and the second operation switch 36 by the occupant based on signals from the first operation switch 35 and the second operation switch 36.

The travel controller 52 is configured to control the acceleration and deceleration of the vehicle 2 according to the driving mode. The travel controller 52 may also be configured to control the steering of the vehicle 2 in addition to the acceleration and deceleration of the vehicle 2. The travel controller 52 executes autonomous driving control including adaptive cruise control (hereinafter referred to as ACC) and lane keeping assist control (Lane Keeping Assist System, hereinafter referred to as LKAS). The adaptive cruise control is an example of vehicle speed control that controls the acceleration and deceleration of the vehicle 2 to control the vehicle speed of the vehicle 2. The travel controller 52 controls the propulsion device 3 and the brake device 4 to control the acceleration and deceleration of the vehicle 2 and assist the driver in driving. Further, the lane keeping assist control is an example of steering control that controls the steering device 5 to control the steering of the vehicle 2. The travel controller 52 controls the steering device 5 to control the trajectory of the vehicle 2 and assist the driver in driving.

In addition to the above-mentioned controls that assist driving during normal travel, the travel controller 52 also executes driving assistance control for accident prevention to prevent accidents, such as a collision mitigation braking system (hereinafter referred to as CMBS) and a lane departure prevention function. The CMBS is realized by controlling the brake device 4 to decelerate the vehicle 2 after issuing a warning, to avoid or mitigate the collision when there is a risk that the vehicle 2 collides with a preceding vehicle or a pedestrian. The lane departure prevention function is realized by controlling the steering device 5 to change the traveling direction of the vehicle 2 after issuing a warning, when there is a risk that the vehicle 2 deviates from the travel lane.

Further, the driving assistance control for accident prevention may include various controls such as blind spot information (hereinafter referred to as BSI) for collision avoidance, accident reduction steering control for collision avoidance, erroneous operation prevention function for preventing erroneous operation by the driver, such as sudden starts or sudden acceleration, and warning function for a traffic violation. The BSI is realized by control that, when other vehicles are detected diagonally behind the own vehicle in a position that constitutes a blind spot for the driver, notifies the driver of the presence of other vehicles by, for example, displaying a warning mark on the door mirror in that direction. The accident reduction steering control is realized by issuing a warning by audio and display when the vehicle deviates from the lane on the pedestrian side and there is a risk of a collision with a pedestrian, and assisting the steering operation back toward the road. The erroneous operation prevention function is realized by preventing sudden start or acceleration when the driver presses the accelerator pedal 22 while an obstacle such as a nearby wall or a preceding vehicle is detected during travel of the vehicle 2, and by issuing a warning by audio and display. The warning function for the traffic violation is realized by issuing a warning by audio and display when a traffic violation occurs, such as speeding, entering an intersection at a red light, entering a no-entry area, or driving in the wrong direction.

The driving assistance controls for accident prevention issue a warning to the driver to prompt intervention in a driving operation when a travel situation of the vehicle 2 does not comply with traffic rules. That is, the driving assistance control for accident prevention is an operation request control requesting the driver to perform the driving operation to change the travel situation of the vehicle 2 more appropriately.

The driving assistance controls for accident prevention are set to be executable at all times during the travel of the vehicle 2, regardless of the operation of the first operation switch 35 and the second operation switch 36. That is, while the vehicle 2 is traveling, the travel controller 52 continuously determines whether the execution conditions for each control are satisfied based on the surrounding situation recognized by the surrounding situation recognizer 51. Upon determining that the execution conditions for each control are satisfied, the travel controller 52 executes the corresponding control and activates the brake device 4, the steering device 5, the HMI 19, and the like.

When the operation detector 58 detects an ON signal from the first operation switch 35, the travel controller 52 initiates the driving assistance control. When the operation detector 58 detects the OFF signal from the first operation switch 35, the travel controller 52 terminates the driving assistance control. When the operation detector 58 detects the selection signal from the second operation switch 36, the travel controller 52 switches the driving assistance control to be executed or currently being executed to the driving assistance control selected by the selection signal. The selection signal from the second operation switch 36 includes, for example, a signal that selects ACC and LKAS, and a signal that selects only LKAS.

The mode setter 53 is configured to change the driving mode. The driving mode includes a manual driving mode, a driving assistance mode during travel, and a driving assistance mode during stop. The driving assistance modes during travel include the autonomous driving level 1 mode, the autonomous driving level 2 mode, the autonomous driving level 3 mode, the accelerator pedal override mode (hereinafter referred to as APOR mode), or the like. The autonomous driving level 1 mode is a mode in which a degree of driving task imposed on the driver is greater than that in the autonomous driving level 2 mode, or a degree of driving assistance provided to the driver is smaller than that in the autonomous driving level 2 mode. The autonomous driving level 2 mode is a mode in which a degree of driving task imposed on the driver is greater than that in the autonomous driving level 3 mode, or a degree of driving assistance provided to the driver is smaller than that in the autonomous driving level 3 mode. The driving assistance mode during stop includes a start standby mode and a stop hold mode. The driving mode transitions according to the operation by the occupant, the state of the vehicle 2, and the state of the occupant.

In the manual driving mode, the travel controller 52 controls the vehicle 2 based on the driving operations of the driver. More specifically, in the manual driving mode, the travel controller 52 acquires the operation amount of the brake pedal 23 from the brake pedal 23 and controls the brake device 4 based on the operation amount of the brake pedal 23. Further, in the manual driving mode, the travel controller 52 acquires the operation amount of the accelerator pedal 22 from the accelerator pedal 22 and controls the propulsion device 3 based on the operation amount of the accelerator pedal 22. Further, in the manual driving mode, the travel controller 52 acquires the operation amount of the steering wheel 21 from the steering wheel 21 and controls the steering device 5 based on the operation amount of the steering wheel 21.

The driving assistance mode can be set when the vehicle 2 is traveling. When the LKAS is selected in the driving assistance mode, the travel controller 52 executes the lane keeping assistance control to cause the vehicle 2 to travel along the lane. The lane information is included in the surrounding situation recognized by the surrounding situation recognizer 51.

Further, when ACC is selected in the driving assistance mode, the travel controller 52 controls the acceleration and deceleration of the vehicle 2 according to the surrounding situation, in addition to the control of the LKAS. In another embodiment, control of ACC and LKAS may be executed independently. The surrounding situations include, for example, a preceding vehicle traveling in front of the vehicle 2. In the driving assistance mode, the travel controller 52 controls the propulsion device 3 and the brake device 4 so as to maintain the inter-vehicle distance between the vehicle 2 and the preceding vehicle traveling in front of the vehicle 2 equal to or more than a prescribed value, and to maintain the vehicle speed at a target vehicle speed within a range in which the inter-vehicle distance can be maintained. The travel controller 52 acquires the position and speed of the preceding vehicle based on the surrounding situations acquired by the surrounding situation recognizer 51. The target vehicle speed may be set by the driver. The target vehicle speed may be set by the operation on the display device 31 or the operation switch by the driver. Further, in the driving assistance mode, the travel controller 52 may control the propulsion device 3 and the brake device 4 based on signal information about traffic lights and sign information acquired by the surrounding situation recognizer 51.

The APOR mode is set as the accelerator pedal 22 is pressed when the driving mode is the driving assistance mode. In the APOR mode, the travel controller 52 controls the propulsion device 3 based on the pressing amount applied to the accelerator pedal 22. This enables the vehicle 2 to accelerate according to the accelerator pedal operation by the driver.

In the driving assistance mode, when the preceding vehicle decelerates and stops, the travel controller 52 stops the vehicle 2 while maintaining the inter-vehicle distance between the vehicle 2 and the preceding vehicle. Further, in the driving assistance mode, the travel controller 52 may acquire traffic light information and stop the vehicle 2 at a stop line according to the traffic light information.

Further, when LKAS is selected in the driving assistance mode, the travel controller 52 executes the lane keeping assist control to cause the vehicle 2 to travel along the lane, in addition to the ACC described above. The travel controller 52 executes the travel control including the driving assistance based on the determination result of the driver state determiner 56.

The notifier 59 makes a notification to the driver via the HMI 19 when the driver state determiner 56 determines that the state of the driver is abnormal.

When the driver state determiner 56 determines that the state of the driver is abnormal, the emergency controller 54 executes emergency control to ensure the safety of the vehicle 2 and the driver. The emergency control is executed regardless of the driving level or the driving state of the vehicle 2. For example, the emergency control is executed while the vehicle 2 is stopped or traveling, or while the ACC or the LKAS is executed, or while the ACC and the LKAS are simultaneously executed. The emergency control takes precedence over the driving operation by the driver and the driving assistance control executed by the travel controller 52, as described below. When the state of the driver is determined as abnormal, the emergency controller 54 executes the following controls: in-vehicle notification to the occupant, suppression of acceleration of the vehicle 2, and lane keeping control of the vehicle 2. If the abnormal state of the driver continues thereafter, the emergency controller 54 confirms the abnormal state of the driver and executes the following controls: external notification, deceleration of the vehicle 2, and lane change of the vehicle 2 to bring the vehicle 2 to a stop in the travel lane or on the road shoulder. After the vehicle 2 is brought to a stop, the emergency controller 54 executes controls for contacting a hospital or the like and for maintaining the stopped state of the vehicle.

Next, an example of the vehicle control procedure executed by the vehicle control device 1 will be described. Here, a case where level 1 or 2 autonomous driving control is performed will be described.

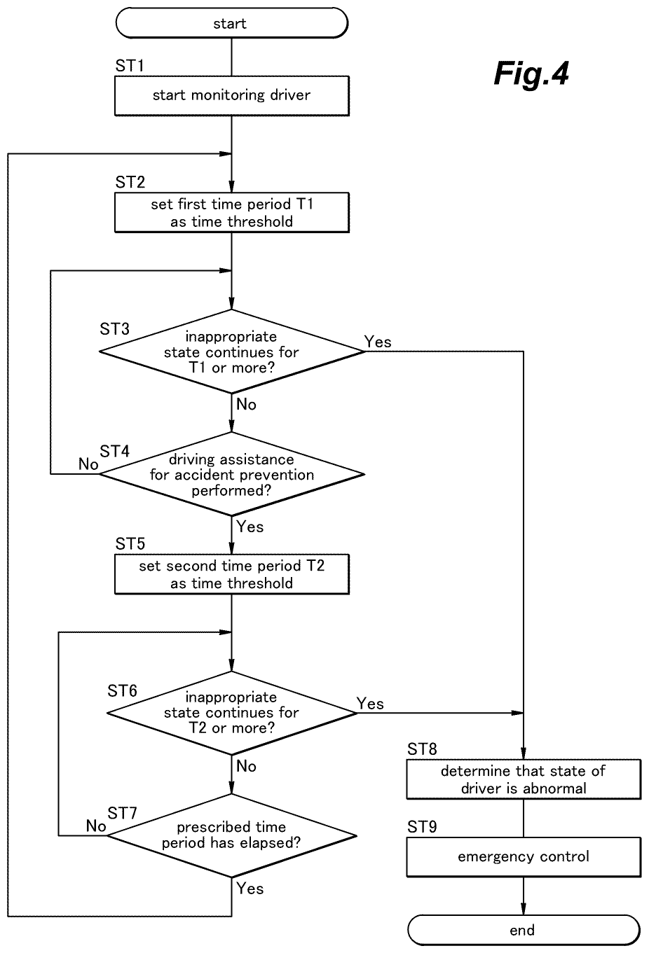

FIG. 4 is a flowchart showing the procedure for driving assistance control by the control device. When the ignition switch of the vehicle 2 is turned on, the vehicle control device 1 initiates the vehicle control shown in FIG. 4. First, the vehicle control device 1 starts monitoring the driver using the occupant monitoring device 18 (ST1). In monitoring the driver, the vehicle control device 1 recognizes the state of the driver using the occupant monitoring device 18 and determines whether the state of the driver is normal or abnormal.

Next, the vehicle control device 1 sets the prescribed first time period T1 as the time threshold for the inappropriate state (ST2). The process of step ST2 may be performed before the process of step ST1.

After the processes of the steps ST1 and ST2, the vehicle control device 1 determines whether the inappropriate state of the driver continues for the first time period T1 or more (ST3). The count of the inappropriate state starts from the time point when the state of the driver is determined as the inappropriate state by the driver state determiner 56, and is reset when the state of the driver returns to the surroundings monitoring state (appropriate state).

The vehicle control device 1 proceeds to step ST4 when the inappropriate state of the driver has not continued for the first time period T1 or more (ST3: No), and proceeds to step ST8 when the inappropriate state of the driver has continued for the first time period T1 or more (ST3: Yes). In step ST4, the vehicle control device 1 determines whether a specific driving assistance by the travel controller 52, specifically the driving assistance for accident prevention, is being executed. When the driving assistance for accident prevention is not being performed (ST4: No), the vehicle control device 1 returns the process to step ST3.

On the other hand, when the driving assistance for accident prevention is being performed (ST4: Yes), the vehicle control device 1 sets the second time period T2 as the time threshold value of the inappropriate state (ST5). The second time period T2 is shorter than the first time period T1. The second time period T2 may be a constant value, or may be a value that varies depending on the control state, such as the mode of autonomous driving control by the travel controller 52 and the type and control amount of the driving assistance control for accident prevention. The second time period T2 will be described in detail later.

After the process of step ST5, the vehicle control device 1 determines whether the inappropriate state of the driver continues for the second time period T2 or more (ST6). The count of the inappropriate state starts from the time point when the state of the driver is determined as the inappropriate state by the driver state determiner 56, and is reset when the state of the driver returns to the surroundings monitoring state (appropriate state).

When the inappropriate state of the driver has occurred before the process proceeds to step ST5, that is, before the driving assistance for accident prevention is initiated, the count started before the initiation of the driving assistance continues.

When the count that was started before the initiation of the driving assistance is equal to or longer than the second time period T2 at the time point when the process proceeds to step ST6, the vehicle control device 1 determines that the inappropriate state of the driver has continued for the second time period T2 or more (Yes) at the time point when the process proceeds to step ST6. In this case, the vehicle control device 1 immediately proceeds to step ST8.

When the inappropriate state of the driver does not continue for the second time period T2 or more in the process of step ST6 (No), the vehicle control device 1 determines whether the prescribed time period has elapsed from the time point when the driving assistance for accident prevention is initiated (the time point when ST4 became Yes) (ST7). The driving assistance for accident prevention is not performed for a long duration, and the prescribed time period is set to a value that exceeds the normal execution time of the driving assistance for accident prevention.

When the prescribed time period has not elapsed from the time point when the driving assistance for accident prevention is initiated (ST7: No), the vehicle control device 1 returns the process to step ST6. On the other hand, when the prescribed time period has elapsed from the time point when the driving assistance for accident prevention is initiated (ST7: Yes), the vehicle control device 1 returns to step ST2 and sets the first time period T1 as the time threshold for the inappropriate state.

When the inappropriate state of the driver continues for the first time period T1 or more in step ST3 (Yes), and when the inappropriate state of the driver continues for the second time period T2 or more in step ST6 (Yes), the vehicle control device 1 determines that the state of the driver is abnormal (ST8). Thereafter, the vehicle control device 1 executes the above-mentioned emergency control (ST9).

The second time period T2, which is set as the time threshold in step ST5, is shorter than the first time period T1, which is set as the time threshold in step ST2. In other words, when the driving assistance for accident prevention is performed (ST4: Yes), unless the prescribed time period has elapsed (ST7: No), the time threshold is set smaller than when the driving assistance for accident prevention is not performed (ST4: No). Accordingly, the state of the driver is more likely to be determined as abnormal.

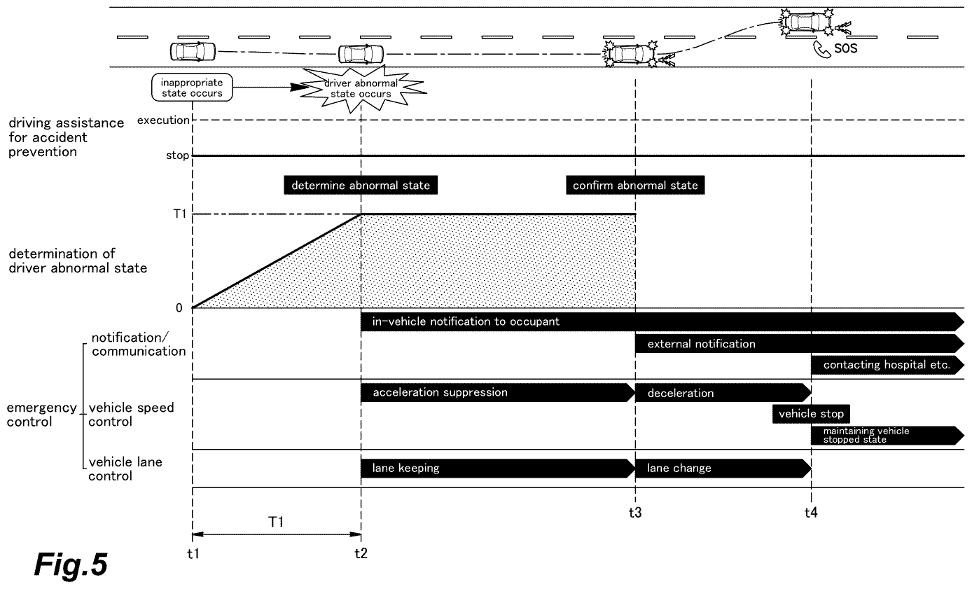

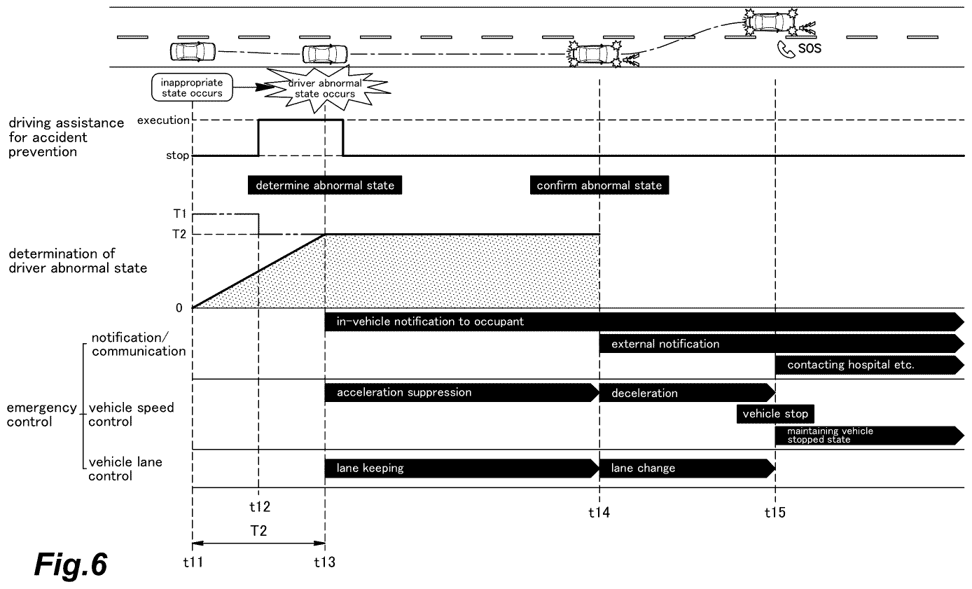

Next, the operation of the vehicle 2 in a case where the vehicle control device 1 executes such vehicle control will be described with reference to FIGS. 5 and 6.

FIG. 5 is a time chart showing an example of the driving assistance control when the vehicle control device 1 is not performing the driving assistance for accident prevention. At a time point t1, the vehicle control device 1 determines that the state of the driver has changed from the appropriate state (surrounding monitoring state) in level 2 autonomous driving to the inappropriate state. Since the driving assistance for accident prevention is not being performed, the first time period T1 is set as the time threshold. At a time point t2 when the inappropriate state continues for the first time period T1, the vehicle control device 1 determines that the state of the driver is abnormal. Thereafter, the vehicle control device 1 executes the following controls: in-vehicle notification to the occupant, suppression of acceleration of the vehicle 2, and lane keeping control.

At a time point t3, when the inappropriate state of the driver continues for the prescribed time period despite the in-vehicle notification being issued, the vehicle control device 1 confirms the abnormal state of the driver. When the abnormal state is confirmed, the vehicle control device 1 executes the emergency controls including: external notification, deceleration of the vehicle 2, and lane change. At a time point t4, when the vehicle control device 1 brings the vehicle 2 to a stop in the travel lane or on the road shoulder, the vehicle control device 1 executes controls for contacting a hospital or the like and for maintaining the stopped state of the vehicle.

FIG. 6 is a time chart showing an example of the driving assistance control when the vehicle control device 1 performs the driving assistance for accident prevention. At a time point t11, the vehicle control device 1 determines that the state of the driver has changed from the appropriate state (surrounding monitoring state) in level 2 autonomous driving to the inappropriate state. At the time point t11, since the driving assistance for accident prevention is not being performed, the first time period T1 is set as the time threshold.

At a time point t12 before the first time period T1 elapses from the time point t11, the driving assistance for accident prevention is performed. Then, the second time period T2, which is shorter than the first time period T1 is set as the time threshold. In the illustrated example, at the time point t12 when the driving assistance for accident prevention is performed, the count of the inappropriate state is shorter than the second time period T2. Accordingly, the count started before the initiation of the driving assistance for accident prevention continues.

At a time point t13, when the inappropriate state has continued for the second time period T2 from the time point t11, the vehicle control device 1 determines that the state of the driver is abnormal. Thereafter, the vehicle control device 1 executes the following controls: in-vehicle notification to the occupant, suppression of acceleration of the vehicle 2, and lane keeping control.

If the driving assistance for accident prevention is performed after the time point t13 at which the second time period T2 has elapsed from the time point t11, the count of the inappropriate state exceeds the second time period T2 at the time point when the driving assistance for accident prevention is performed, and therefore the vehicle control device 1 immediately determines that the state of the driver is abnormal. In this case, the vehicle control device 1 executes the following controls: in-vehicle notification to the occupant, suppression of acceleration of the vehicle 2, and lane keeping control of the vehicle 2 immediately after the driving assistance for accident prevention is performed.

Alternatively, the vehicle control device 1 may determine that the state of the driver is abnormal immediately at the time point when the driving assistance for accident prevention is performed, that is, based on the fact that the driving assistance is performed, independently of the count used to determine the abnormal state of the driver.

At a time point t14, when the inappropriate state of the driver continues for the prescribed time period despite the in-vehicle notification being issued, the vehicle control device 1 confirms the abnormal state of the driver. When the abnormal state is confirmed, the vehicle control device 1 executes following controls: external notification, deceleration of the vehicle 2, and lane change of the vehicle 2. At the time point t14, when the vehicle control device 1 brings the vehicle 2 to a stop in the travel lane or on the road shoulder, the vehicle control device 1 executes various emergency controls including contacting a hospital or the like and maintaining the stopped state of the vehicle.

Accordingly, when the driving assistance for accident prevention is performed (FIG. 6), the vehicle control device 1 hasten activation of the notification (the time point t13) relative to the time point t2, and hasten initiation of deceleration of the vehicle 2 (the time point t14) and stopping of the vehicle 2 (a time point t15) relative to the time points t3 and t4, as compared to when the driving assistance for accident prevention is not performed (FIG. 5).

As described above, the second time period T2 is set to a different value depending on the control state, such as the mode of autonomous driving control executed by the travel controller 52 and the type and amount of driving assistance control for accident prevention. For example, the vehicle control device 1 may set the second time period T2 to be smaller when both controls of the CMBS and the lane departure prevention function are being executed, as compared to when only lane departure prevention control is being executed. Further, the vehicle control device 1 may set the second time period T2 to be smaller when the control of the CMBS or the lane departure prevention function is being executed, as compared to when the control for warning for the traffic violation is being executed.

The vehicle control device 1 may set the second time period T2 to be smaller when the autonomous driving level 2 mode is being executed, as compared to when the autonomous driving level 1 mode is being executed. In this case, when the autonomous driving level 2 mode is being executed, the state of the driver is more likely to be determined as abnormal than when the autonomous driving level 1 mode is being executed.

As described above, according to the vehicle control device 1 according to the embodiment, the state of the driver is more likely to be determined as abnormal when driving assistance is performed by the driving assister. Accordingly, it is possible to appropriately determine the abnormal state of the driver according to the driving situation and to reduce the delay in notifying the driver.

The above embodiment is configured as follows.

A vehicle control device including: a surrounding situation recognizer 51 configured to recognize a surrounding situation of a vehicle 2; a travel controller 52 as a driving assister configured to perform driving assistance for the vehicle 2 based on a recognition result of the surrounding situation recognizer 51; and a driver state determiner 56 configured to determine whether a state of a driver is normal or abnormal based on an image captured by an in-vehicle camera 25 that captures an image of the driver of the vehicle 2. The driver state determiner 56 is configured such that the state of the driver is more likely to be determined as abnormal when the driving assistance is being performed by the travel controller 52 than when the driving assistance is not being performed.

According to this aspect, when the driving assistance by the travel controller 52 is performed, the state of the driver is more likely to be determined as abnormal by the driver state determiner 56. Accordingly, it is possible to appropriately determine the abnormal state of the driver according to the driving situation and to reduce the delay in notifying the driver. This improves safety during the performance of driving assistance by the travel controller 52.

The driver state determiner 56 is configured to set a time threshold based on the driving assistance performed by the travel controller 52, and to determine that the state of the driver is abnormal when an inappropriate state, in which the driver whose image is captured by the in-vehicle camera 25 does not satisfy a prescribed suitability criterion, continues for the time threshold (the first time period T1 or the second time period T2)or more. The driver state determiner 56 is further configured to set the time threshold to be smaller when the driving assistance is being performed by the travel controller 52 than when the driving assistance is not being performed.

According to this aspect, by setting the time threshold for determining the abnormal state of the driver to be smaller when the driving assistance is being performed, it is possible to determine the abnormal state of the driver at an earlier timing.

The vehicle control device 1 further includes a notifier 59 configured to make a notification to the driver when the driver state determiner 56 determines that the state of the driver is abnormal. The notifier 59 is configured to hasten activation of the notification when the driving assistance is being performed by the travel controller 52 as compared to when the driving assistance is not being performed.

According to this aspect, when the state of the driver is determined as abnormal when the driving assistance is being performed, it is possible to improve safety by making the notification earlier. Further, when the driving assistance is not being performed, the notification is made at a slower timing than when the driving assistance is being performed, so that the driver does not experience annoyance.

The vehicle control device 1 further includes an emergency controller 54 configured to decelerate or stop the vehicle 2 when the driver state determiner 56 determines that the state of the driver is abnormal. The emergency controller 54 is configured to hasten the initiation of deceleration of the vehicle 2 or stopping of the vehicle 2 when the driving assistance is being performed by the travel controller 52 as compared to when the driving assistance is not being performed.

According to this aspect, when the state of the driver is determined as abnormal when the driving assistance is being performed, it is possible to improve safety by hastening the deceleration or stopping of the vehicle 2. Further, when the driving assistance is not being performed, the deceleration or stopping of the vehicle 2 is performed at a slower timing than when the driving assistance is being performed, so that the driver does not experience annoyance.

The travel controller 52 is capable of executing driving assistance control of plural types for the vehicle 2, and the driver state determiner is configured such that the state of the driver is more likely to be determined as abnormal when specific driving assistance control among the driving assistance control of the plural types is being performed by the driving assister than when the specific driving assistance is not being performed.

According to this aspect, when the specific driving assistance control is performed, the state of the driver is more likely to be determined as abnormal by the driver state determiner 56. Accordingly, it is possible to appropriately determine the abnormal state of the driver according to the driving situation and to reduce the delay in notifying the driver.

The specific driving assistance control is the driving assistance control that includes operation request control requesting the driver to perform a driving operation to change a travel situation of the vehicle 2.

According to this aspect, when the driving assistance control that includes the operation request control for accident prevention requesting the driver to perform such driving operations is being executed, the state of the driver is more likely to be determined as abnormal. This improves safety during the execution of such driving assistance for accident prevention.

The specific driving assistance control is any one of collision avoidance control for avoiding a collision between the vehicle 2 and an obstacle recognized by the surrounding situation recognizer 51, lane departure prevention control for preventing the vehicle 2 from deviating from an own lane, and erroneous operation prevention control for preventing erroneous driving operation by the driver.

According to this aspect, when the driving assistance for accident prevention is being performed, the state of the driver is more likely to be determined as abnormal. This improves safety during the performance of the driving assistance for accident prevention.

The driver state determiner 56 is configured such that the state of the driver is more likely to be determined as abnormal when the driving assistance is being performed than when the driving assistance is not being performed, when an inappropriate state, in which the driver whose image is captured by the in-vehicle camera 25 does not satisfy a prescribed suitability criterion, has continued since before initiation of the driving assistance.

According to this aspect, when the inappropriate state of the driver has continued since before the initiation of the driving assistance, it is possible to more easily determine the abnormal state of the driver based on the state of the driver before the initiation of the driving assistance. This further improves safety during the performance of the driving assistance by the travel controller 52.

The driver state determiner 56 is configured to determine that the state of the driver is abnormal when the inappropriate state continues for a prescribed time threshold (the first time period T1 or the second time period T2) or more, and the driver state determiner 56 is further configured to set the time threshold to be smaller when the driving assistance is being performed by the travel controller 52 than when the driving assistance is not being performed.

According to this aspect, when the inappropriate state of the driver has continued since before the initiation of the driving assistance, it is possible to determine the abnormal state of the driver at an earlier timing based on the state of the driver before the initiation of the driving assistance. For example, it is possible to determine the abnormal state of the driver at the same time as the initiation of the driving assistance.

The driver state determiner 56 is configured to restore the time threshold that has been set smaller to the original time threshold when the inappropriate state, which has continued since before the initiation of the driving assistance by travel controller 52, ceases after the driving assistance is performed.

According to this aspect, it is possible to determine the abnormal state of the driver at an earlier timing when the driving assistance is being performed, and to suppress the determination of the abnormal state of the driver at an excessively earlier timing after the inappropriate state has ceased.

The driver state determiner 56 is configured to determine that the state of the driver is abnormal based on the fact that the driving assistance by the travel controller 52 is performed.

According to this aspect, when the driving assistance is being performed, it is possible to determine the abnormal state of the driver at an earlier timing. This further improves safety during the performance of the driving assistance by the travel controller 52.

This concludes the explanation of the specific embodiment, but the present invention is not limited to the configuration of the above embodiment and can be widely modified and implemented.

For example, in the above embodiment, the driver state determiner 56 sets a time threshold based on the driving assistance, and determines that the state of the driver is abnormal when the inappropriate state continues for the time threshold or more. However, the driver state determiner 56 may vary the size of the prescribed area 37 in the image shown in FIG. 2 and fix the time threshold based on the driving assistance.

Further, the specific structures, arrangements, quantities, and materials of each component or portion, as well as the specific contents and order of the processes, may be appropriately modified without departing from the scope of the present invention. Further, not all components shown in the above embodiments are essential, and those skilled in the art can select the components as appropriate.

1. A vehicle control device comprising:
a surrounding situation recognizer configured to recognize a surrounding situation of a vehicle;
a driving assister configured to perform driving assistance for the vehicle based on a recognition result of the surrounding situation recognizer; and
a driver state determiner configured to determine whether a state of a driver is normal or abnormal based on an image captured by an in-vehicle camera that captures an image of the driver of the vehicle, wherein
the driver state determiner is configured such that the state of the driver is more likely to be determined as abnormal when the driving assistance is being performed by the driving assister than when the driving assistance is not being performed.

2. The vehicle control device according to claim 1, wherein the driver state determiner is configured to set a time threshold based on the driving assistance performed by the driving assister, and to determine that the state of the driver is abnormal when an inappropriate state, in which the driver whose image is captured by the in-vehicle camera does not satisfy a prescribed suitability criterion, continues for the time threshold or more; and
the driver state determiner is further configured to set the time threshold to be smaller when the driving assistance is being performed by the driving assister than when the driving assistance is not being performed.

3. The vehicle control device according to claim 2, further comprising a notifier configured to make a notification to the driver when the driver state determiner determines that the state of the driver is abnormal, wherein
the notifier is configured to hasten activation of the notification when the driving assistance is being performed by the driving assister as compared to when the driving assistance is not being performed.

4. The vehicle control device according to claim 3, further comprising an emergency controller configured to decelerate or stop the vehicle when the driver state determiner determines that the state of the driver is abnormal, wherein
the emergency controller is configured to hasten initiation of deceleration of the vehicle or stopping of the vehicle when the driving assistance is being performed by the driving assister as compared to when the driving assistance is not being performed.

5. The vehicle control device according to claim 1, wherein the driving assister is capable of executing driving assistance control of plural types for the vehicle, and
the driver state determiner is configured such that the state of the driver is more likely to be determined as abnormal when specific driving assistance control among the driving assistance control of the plural types is being performed by the driving assister than when the specific driving assistance is not being performed.

6. The vehicle control device according to claim 5, wherein the specific driving assistance control is the driving assistance control that includes operation request control requesting the driver to perform a driving operation to change a travel situation of the vehicle.

7. The vehicle control device according to claim 6, wherein the specific driving assistance control is any one of collision avoidance control for avoiding a collision between the vehicle and an obstacle recognized by the surrounding situation recognizer, lane departure prevention control for preventing the vehicle from deviating from an own lane, and erroneous operation prevention control for preventing erroneous driving operation by the driver.

8. The vehicle control device according to claim 1, wherein the driver state determiner is configured such that the state of the driver is more likely to be determined as abnormal when the driving assistance is being performed than when the driving assistance is not being performed, when an inappropriate state, in which the driver whose image is captured by the in-vehicle camera does not satisfy a prescribed suitability criterion, has continued since before initiation of the driving assistance.

9. The vehicle control device according to claim 8, wherein the driver state determiner is configured to determine that the state of the driver is abnormal when the inappropriate state continues for a prescribed time threshold or more, and
the driver state determiner is further configured to set the time threshold to be smaller when the driving assistance is being performed by the driving assister than when the driving assistance is not being performed.

10. The vehicle control device according to claim 9, wherein the driver state determiner is configured to restore the time threshold that has been set smaller to the original time threshold when the inappropriate state, which has continued since before the initiation of the driving assistance, ceases after the driving assistance is performed.

11. The vehicle control device according to claim 1, wherein the driver state determiner is configured to determine that the state of the driver is abnormal based on the fact that the driving assistance by the driving assister is performed.
